(19) United States
(12) Patent Application Publication
(10) Pub. No.: US 2026/0248316 A1
(43) Pub. Date: Aug. 27, 2026

(54) BEVERAGE BREWING SYSTEM

(71) Applicant: COULEE COFFEE COMPANY, KETCHUM, ID (US)

(72) Inventors: HAROLD EDWARD "TED" AYLIFFE, KETCHUM, ID (US); GREGORY MARK DITTAMI, SUN VALLEY, ID (US)

(73) Assignee: COULEE COFFEE COMPANY, KETCHUM, ID (US)

(21) Appl. No.: 18/992,316

(22) PCT Filed: Jun. 30, 2023
(86) PCT No.: PCT/US2023/026822

§ 371 Date: Jan. 8, 2025

Related U.S. Application Data
(63) Continuation of application No. 18/026,970, filed on Jul. 8, 2022.
(60) Provisional application No. 63/219,569, filed on Jul. 8, 2021.
(60) Provisional application No. 63/454,029, filed on Mar. 22, 2023.

(51) Int. Cl. A47J 31/057; A47J 31/44

(52) U.S. Cl. CPC A47J 31/0573; A47J 31/4457; A47J 2202/00; A47J 2203/00

(57) ABSTRACT

A beverage brewing system includes a case, a reservoir, a pump, a heating element, and a holder. The case defines a cup reception bay for receiving a cup and a nozzle assembly positioned above the cup reception bay. The reservoir is positioned within the case for containing a fluid. The pump is positioned within the case for pumping the fluid from the reservoir to the nozzle assembly. The heating element is positioned within the case for heating the fluid as the fluid is pumped to the nozzle assembly. The holder holds a pour-over bag that has an opening configured to receive a beverage precursor. The nozzle assembly pours the fluid into the pour-over bag through the opening, and the fluid flows through the beverage precursor and through the pour-over bag into a cup positioned within the cup reception bay.

### CROSS-REFERENCE TO RELATED APPLICATIONS AND PRIORITY CLAIM

The present application is a 371 National Stage entry of International PCT

Application No. PCT/US23/026822 filed Jun. 30, 2023, which is a continuation-in-part of U.S. patent application Ser. No. 18/026,970 filed 17 Mar. 2023, which is a National Stage entry application from PCT International Application Serial No. PCT/US22/36588 filed 8 Jul. 2022, which claims the benefit of US Provisional Patent Application Ser. No. 63/219,569 filed 8 Jul. 2021. The present application also claims the benefit of US Provisional Patent Application Serial Nos. 63/424,097 filed 9 Nov. 2022 and 63/454,029 filed 22 Mar. 2023. The disclosures of all of the aforementioned applications are hereby incorporated in their entireties by this reference as if fully set forth herein.

### TECHNICAL FIELD

The present disclosure relates generally to beverage brewing systems, and more particularly to single-serve, disposable and pour-over beverage brewing systems.

### BACKGROUND

Single use beverage brewing machines typically brew one or more beverages, such as coffee or tea, using a prepackaged beverage precursor, such as coffee grounds or tea leaves. The beverage precursor is typically steeped in a fluid, typically water, until the beverage is extracted from the beverage precursor. The beverage precursor is typically stored in a sealed package that is inserted into the beverage brewing machine and the beverage brewing machine accesses the sealed package to brew the beverage. However, because the package is sealed, the user cannot control the amount of beverage precursor used to brew the beverage. Additionally, the sealed package prevents the user from brewing the beverage using different brewing methods, such as the pour-over method, that may result in different beverage flavor profiles. Third, the water delivery mechanisms of the water to the beverage precursor are often spatially limited in a way that only discrete, limited sections of the precursor are exposed to the high temperature water, limiting the extraction of the flavor. Fourth, the sealed packages may be made from non-biodegradable materials to retain the flavor and aroma of the beverage precursor. Accordingly, single use beverage brewing systems may be less operationally flexible and may be less environmentally sustainable than alternative brewing methods. Finally, the sealed packages are often composed of petroleum-based plastics that might have leachable components that might have undesirable health effects for the consumer of the beverage.

### SUMMARY

One aspect of the present disclosure is directed to a beverage brewing system. The beverage brewing system includes a case, a reservoir, a pump, a heating element, and a holder. The case defines a cup reception bay for receiving a cup and a nozzle assembly positioned above the cup reception bay. The reservoir is positioned within the case for containing a fluid. The pump is positioned within the case for pumping the fluid from the reservoir to the nozzle assembly. The heating element is positioned within the case for heating the fluid to a precise temperature set point either as the fluid is pumped to the nozzle assembly or by pre-heating the fluid in a boiler tank. The holder holds a pour-over bag beneath the nozzle assembly. The pour-over bag has an opening configured to receive the fluid. The pour-over bag hangs from the holder with the opening oriented toward the nozzle assembly. The nozzle assembly pours the fluid into the pour-over bag through the opening, and the fluid flows through a beverage precursor within the pour-over bag and through the pour-over bag into a cup positioned within the cup reception bay.

Another aspect of the present disclosure relates to a method of brewing a beverage with a beverage brewing system. The method includes positioning a cup within a cup reception bay of the beverage brewing system. The beverage brewing system includes a nozzle assembly positioned above the cup, a holder positioned above the cup, a reservoir, a pump, and a heating element. The method also includes hanging a pour-over bag on the holder. The pour-over bag contains a beverage precursor and has an opening oriented toward the nozzle assembly. The method further includes pumping a flow of a fluid from the reservoir to the nozzle assembly with the pump. The method also includes heating the flow of the fluid with the heating element or pre-heating the fluid in a boiler tank. The method further includes pouring the flow of the fluid into the pour-over bag through the opening with the nozzle assembly. The method also includes seeping the flow of the fluid through the beverage precursor and the pour-over bag into the cup. A key component of the method is the movement of the bag, with respect to the nozzle, or the nozzle, with respect to the bag, to ensure a full exposure of the beverage precursor to the controlled-temperature fluid. Another component of the method is to move the filter bag (e.g. oscillates) in a manner that results in a swirling or mixing of the beverage precursor component to improve the fluid exposure to the beverage precursor and overall extraction.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the embodiments may be realized by reference to the following drawings. In the appended figures, similar components or features may have the same reference label.

FIG. 1 illustrates a front view of an example beverage brewing system for brewing a beverage in accordance with the principals of the present disclosure.

FIG. 2 illustrates a side view of an example beverage brewing system with the internal components illustrated in dashed lines in accordance with the present disclosure.

FIG. 3 illustrates another side view of a portion of an example beverage brewing system with the internal components illustrated in dashed lines in accordance with the present disclosure.

FIG. 4 illustrates a top view of an example oscillation mechanism in accordance with the present disclosure.

FIG. 5 illustrates a side view of an example motor of the oscillation mechanism in accordance with the present disclosure.

FIG. 6 is a schematic diagram of internal components of the beverage brewing system in accordance with the present disclosure.

FIG. 7 is a schematic diagram of internal components of the beverage brewing system in accordance with the present disclosure.

FIG. 8 illustrates a side view of an example pour-over bag in a first, flat configuration in accordance with the present disclosure.

FIG. 9 is a perspective view of an example pour-over bag in a second, expanded configuration in accordance with the present disclosure.

FIG. 10 is a top view of an example pour-over bag in a second, expanded configuration in accordance with the present disclosure.

FIG. 11 is a side view of an example pour-over bag in a second, expanded configuration in accordance with the present disclosure.

FIG. 12 is another side view of an example pour-over bag in a second, expanded configuration in accordance with the present disclosure.

FIG. 13 illustrates a side view of an alternative pour-over bag in a first, flat configuration in accordance with the present disclosure.

FIG. 14 is a perspective view of the pour-over bag illustrated in FIG. 13 in a second, expanded configuration in accordance with the present disclosure.

FIG. 15 is a side view of a portion of the pour-over bag illustrated in FIGS. 13 and 14 in accordance with the present disclosure.

FIG. 16 is a side view of a plurality of pour-over bags illustrated in FIGS. 13-15 in the first, flat configuration during the manufacturing process in accordance with the present disclosure.

FIG. 17 illustrates an example method of brewing a beverage with a beverage brewing system in accordance with the present disclosure.

FIGS. 18A-18B are, respectively, a top perspective view and side view of the pour-over bag illustrated in FIG. 13 in accordance with the present disclosure.

FIG. 19 is a side view of the pour-over bag illustrated in FIG. 14 in accordance with the present disclosure.

FIG. 20 is another side view of the pour-over bag illustrated in FIG. 14 in accordance with the present disclosure.

FIG. 21 is a top view of the pour-over bag illustrated in FIG. 14 in accordance with the present disclosure.

FIG. 22 is a bottom view of the pour-over bag illustrated in FIG. 14 in accordance with the present disclosure.

FIGS. 23A-23D are, respectively, a top perspective view, a top view, a first side view and a second side view of a holder assembly of a first embodiment in a folded configuration in accordance with the present disclosure.

FIGS. 24A-24D are, respectively, a top perspective view, a top view, a first side view and a second side view of the holder assembly of FIGS. 23A-23D in an unfolded configuration in accordance with the present disclosure.

FIGS. 25A-25D are, respectively, a top perspective view, a top view, a first side view and a second side view of the pour-over bag illustrated in FIG. 14, a cup, and the holder assembly of FIGS. 24A-24D.

FIGS. 26A-26D are, respectively, a top perspective view, a top view, a first side view and a second side view of a holder assembly of a second embodiment in accordance with the present disclosure.

FIGS. 27A-27D are, respectively, a top perspective view, a top view, a first side view and a second side view of the pour-over bag illustrated in FIG. 14, a cup, and the holder assembly of FIGS. 26A-26D.

FIGS. 28A-28B are, respectively, a side view of an alternative embodiment of system 100 and a side magnified view of a region of system 100 indicated by circular arrow A in accordance with the present disclosure.

FIGS. 29A-29D are, respectively, a top view, a top perspective view, a first side view and a second side view of a reusable pour-over bag similar to that illustrated in FIG. 14 in accordance with the present disclosure.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

This description provides examples, and is not intended to limit the scope, applicability or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted or combined. Also, aspects and elements described with respect to certain embodiments may be combined in various other embodiments. It should also be appreciated that the following systems, methods, and devices may individually or collectively be components of a larger system, wherein other procedures may take precedence over or otherwise modify their application.

The detailed description of exemplary embodiments herein makes reference to the accompanying drawings, which show exemplary embodiments by way of illustration. While these exemplary embodiments are described in sufficient detail to enable those skilled in the art to practice the disclosure, it should be understood that other embodiments may be realized and that logical changes and adaptations in design and construction may be made in accordance with this disclosure and the teachings herein without departing from the spirit and scope of the disclosure. Thus, the detailed description herein is presented for purposes of illustration only and not of limitation.

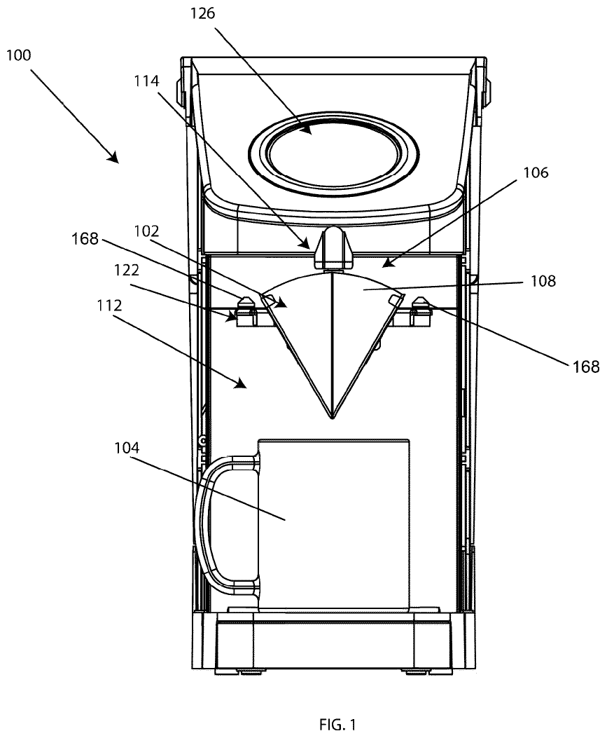

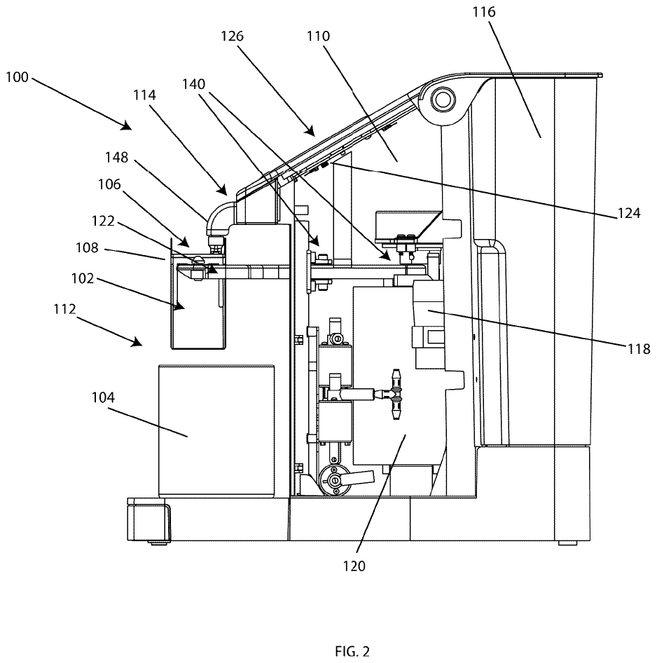

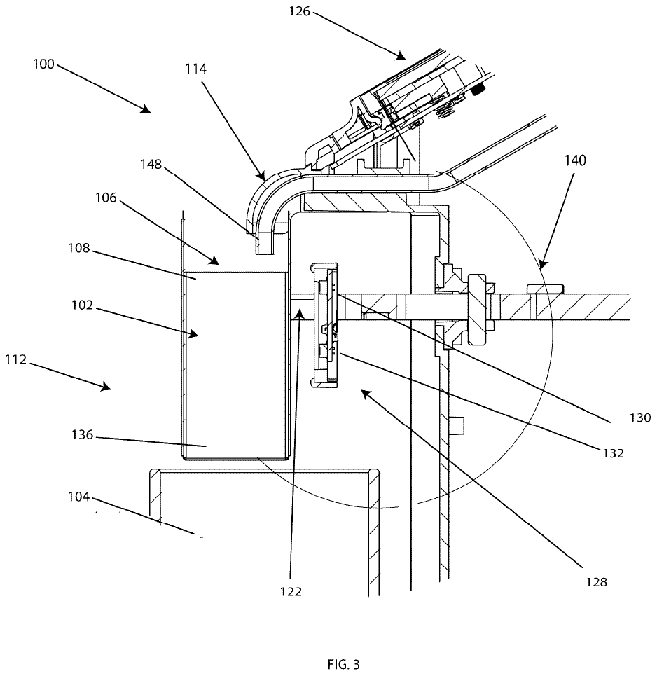

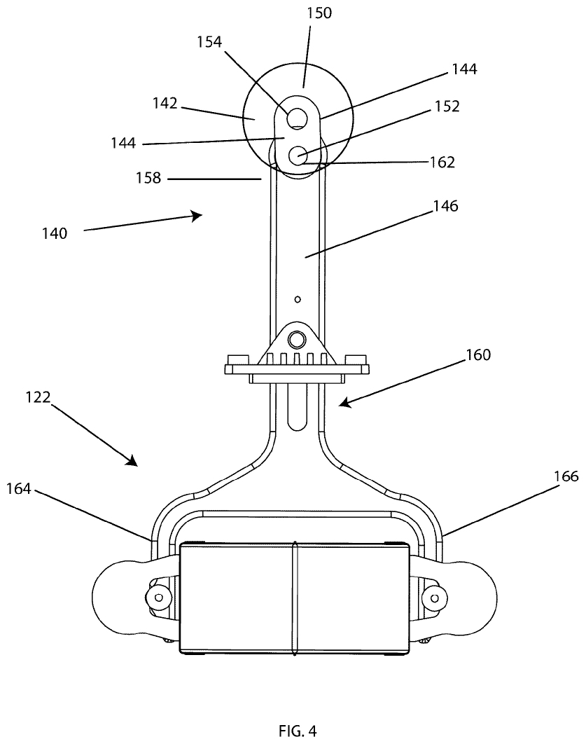

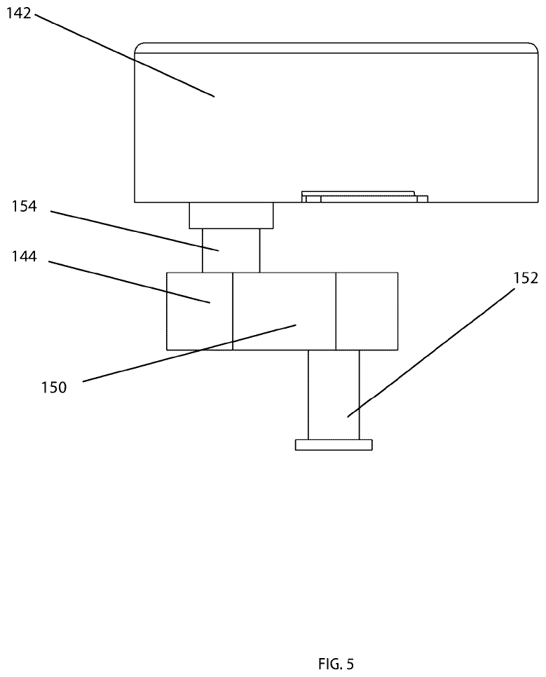

FIG. 1 illustrates a front view of a beverage brewing system 100 for brewing a beverage. FIG. 2 illustrates a side view of the beverage brewing system 100 with the internal components illustrated in dashed lines. FIG. 3 illustrates another side view of a portion of the beverage brewing system 100 with the internal components illustrated in dashed lines. FIG. 4 illustrates a top view of an oscillation mechanism of the beverage brewing system 100. FIG. 5 illustrates a side view of a motor of the oscillation mechanism of the beverage brewing system 100.

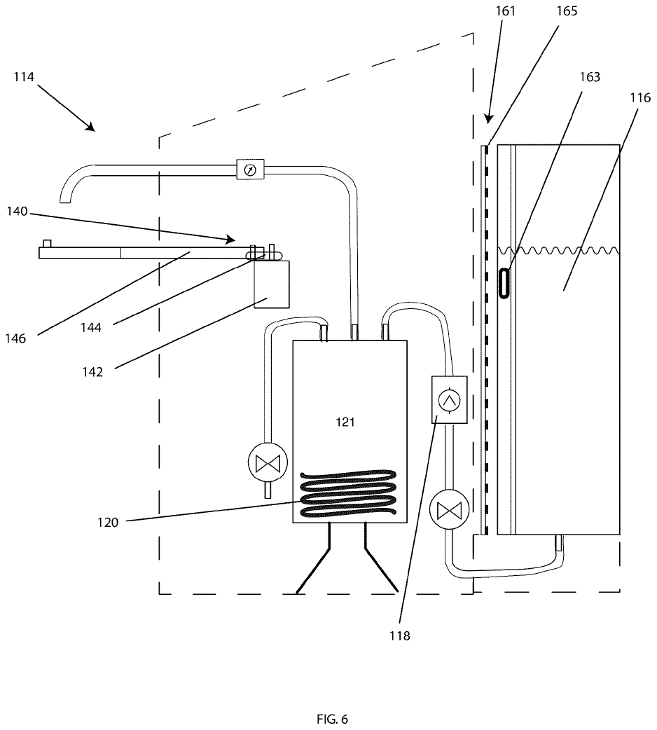

FIG. 6 is a schematic diagram of internal components of the beverage brewing system 100.

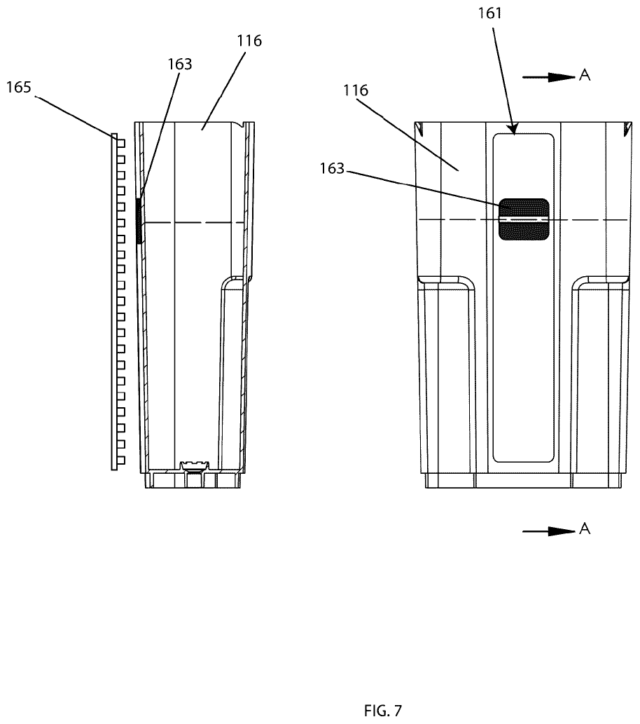

FIG. 7 is a schematic diagram of internal components of the beverage brewing system 100. The beverage brewing system 100 brews the beverage using a pour-over method. Specifically, the beverage brewing system 100 pours a heated fluid into a pour-over bag 102 that contains a beverage precursor. The fluid steeps in the beverage precursor to brew the beverage, such as coffee or tea. The pour-over bag 102 contains the beverage precursor, such as coffee grounds or loose-leaf tea, while the fluid seeps through the beverage precursor and the pour-over bag 102. The pour-over bag 102 separates the brewed beverage fluid from the beverage precursor and drips the brewed beverage fluid into a cup 104. The pour-over bag 102 defines an opening 106 in a top 108 of the pour-over bag 102 to enable a user to insert the beverage precursor into the pour-over bag 102 and to enable the fluid to be poured into the pour-over bag 102. Additionally, the pour-over bag 102 is made from a biodegradable or compostable material that may be better for the environment than conventional single use brewing systems. Thus, the beverage brewing system 100 automates the process of brewing pour-over beverages and is more environmentally friendly. The pour-over bag is also devoid of petroleum-based plastics which may have undesirable health impacts, particularly in applications involving exposure to high temperature fluid.

The beverage brewing system 100 includes a case 110 defining a cup reception bay 112 for receiving the cup 104 and a nozzle assembly 114 positioned above the cup reception bay 112 and the cup 104. The beverage brewing system 100 includes a reservoir 116 positioned within the case 110 for containing the fluid, a pump 118 positioned within the case 110 for pumping the fluid from the reservoir 116 to the nozzle assembly 114, and a heating element 120 positioned within the case 110 for heating the fluid as the fluid is pumped to the nozzle assembly 114,

The beverage brewing system 100 also includes a holder 122 positioned above the cup 104 and below the nozzle assembly 114 within the cup reception bay 112 for holding the pour-over bag 102.

The beverage brewing system 100 further includes a computing device 124 positioned within the case 110 for controlling the beverage brewing system 100 and an interface module 126 attached to the case 110 that enables a user to control the beverage brewing system 100. In alternative embodiments, the beverage brewing system 100 does not include the reservoir 116. Rather, the beverage brewing system 100 is connected to a source (such as the water system) of the fluid that delivers the fluid to the beverage brewing system 100 as the beverage brewing system 100 dispenses the fluid. In another alternative embodiment, the beverage brewing system 100 includes the reservoir 116 and is connected to a source (such as the water system) of the fluid that delivers the fluid to the reservoir 116 as the beverage brewing system 100 dispenses the fluid.

During operations, a user attaches the pour-over bag 102 to the holder 122. In this embodiment, the pour-over bag 102 is pre-filled with the beverage precursor. In an alternative embodiment, the beverage brewing system 100 may include a grinder (not shown) that grinds the beverage precursor and fills the pour-over bag 102 with the beverage precursor. In another alternative embodiment, the user fills the pour-over bag 102 with the beverage precursor and attaches the pour-over bag 102 to the holder 122. The user then fills the cup 104 with the fluid and pours the fluid from the cup 104 into the reservoir 116. In alternative embodiments, a source of the fluid is connected to the beverage brewing system 100 as the beverage brewing system 100 dispenses the fluid. The user positions the cup 104 under the pour-over bag 102 and selects the type of beverage the user wants using the interface module 126. The beverage brewing system 100 automatically brews the selected beverage. Specifically, the computing device 124 controls the pump 118, the heating element 120, and the nozzle assembly 114 to brew the selected beverage. The pump 118 pumps the fluid from the reservoir 116 through the heating element 120. In some embodiments, the pump 118 directly pumps the fluid from the reservoir 116. In alternative embodiments, the pump 118 pressurizes the reservoir 116 with pressurized air and the pressurized air moves the fluid through the heating elements 120. The heating element 120 precisely increases the temperature of the fluid to a predetermined beverage temperature, or to a pre-boil temperature if the set point exceeds the boiling point, and the heated fluid is pumped to the nozzle assembly 114. The nozzle assembly 114 pours the heated fluid through the opening 106 onto the beverage precursor while the bag is oscillated under the nozzle to increase the distribution. The nozzle may be equipped with a fluid-splitting apparatus that splits the fluid in divergent directions to further increase the fluid distribution. The heated fluid steeps in the beverage precursor and drips through the pour-over bag 102 into the cup 104. Once the cup 104 has been filled, the beverage brewing system 100 stops pumping the fluid to the nozzle assembly 114 and the user removes the cup 104 from the cup reception bay 112.

To control the brewing process, the beverage brewing system 100 may include a level detection system 128. The level detection system 128 includes at least one level detector for detecting the level of the fluid in at least one of the pour-over bag 102 and the cup 104. In some embodiments, the level detection system 128 only detects the level of the fluid in the pour-over bag 102. In other embodiments, the level detection system 128 only detects the level of the fluid in the cup 104. In still more embodiments, the level detection system 128 detects the level of the fluid in both the pour-over bag 102 and the cup 104. In alternative embodiments, the water level in the reservoir 116 and the cup 104 may be used to determine the amount of water in the pour-over bag 102. In an alternate embodiment, a flow sensor is positioned prior to the nozzle to measure the exact fluid delivery to the beverage precursor.

In another possible embodiment, illustrated in FIG. 3, the level detection system 128 detects the level of the fluid in both the pour-over bag 102 and the cup 104. Specifically, in the illustrated embodiment, the level detection system 128 includes a first level detector 130 for detecting the level of the fluid in the pour-over bag 102, a second level detector 132 for detecting the level of the fluid in the pour-over bag 102, and a third level detector 134 for detecting the level of the fluid in the cup 104. More specifically, the first level detector 130 is positioned within the cup reception bay 112 proximate the top 108 of the pour-over bag 102 for detecting the level of the fluid in the pour-over bag 102 near the opening 106 of the pour-over bag 102. The second level detector 132 is positioned within the cup reception bay 112 proximate a bottom 136 of the pour-over bag 102 for detecting the level of the fluid in the pour-over bag 102 near the bottom 136 of the pour-over bag 102. The third level detector 134 is positioned within the cup reception bay 112 proximate a top 138 of the cup 104 for detecting the level of the fluid in the cup 104 near the top 138 of the cup 104. Multiple configurations can be envisioned with all detectors or just individual detectors.

In the illustrated embodiment, the first, second, and third level detectors 130-134 are infrared detectors (thermopiles). Specifically, the first, second, and third level detectors 130-134 are each positioned to detect a temperature of either the pour-over bag 102 or the cup 104. As the fluid is poured into the pour-over bag 102 and the cup 104, the temperature of the pour-over bag 102 and the cup 104 increases. Based on experimental data and the selected beverage, the fluid has reached a predetermined level within either the pour-over bag 102 or the cup 104 once the temperature of either the pour-over bag 102 or the cup 104 exceeds a predetermined temperature. Thus, the first, second, and third level detectors 130-134 are positioned and configured to detect the temperature of the pour-over bag 102 and the cup 104 to determine the level of the fluid within the pour-over bag 102 and the cup 104.

For example, the first level detector 130 is positioned proximate the top of the pour-over bag 102. The first level detector 130 monitors and detects the temperature of the top 108 of the pour-over bag 102. The first level detector 130 is configured to turn off the pump 118 when the temperature of the pour-over bag 102 exceeds a first predetermined temperature. Once the temperature of the top 108 of the pour-over bag 102 exceeds the first predetermined temperature, the level of the fluid is proximate the top 108 of the pour-over bag 102. To prevent the pour-over bag 102 from overfilling with the fluid, the computing device 124 turns off the pump 118 until the temperature of the top 108 of the pour-over bag 102 decreases by a certain percentage, ratio, or fixed magnitude below the first predetermined temperature, indicating that the level of the fluid is sufficiently below the top 108 of the pour-over bag 102 to begin pouring again. Alternatively, the system may monitor the rate of change in temperature of the top 108 of the pour-over bag to determine the degree of draining of the water in the bag. Thus, the first level detector 130 enables the computing device 124 to control the brewing process and prevent the pour-over bag 102 from overfilling with the fluid.

The level detection system 128 may also include the second level detector 132. The second level detector 132 is positioned proximate the bottom 136 of the pour-over bag 102. The second level detector 132 monitors and detects the temperature of the bottom 136 of the pour-over bag 102. The second level detector 132 is configured to turn on the pump 118 when the temperature of the pour-over bag 102 decreases below a second predetermined temperature. Once the temperature of the bottom 136 of the pour-over bag 102 decreases below the second predetermined temperature, the level of the fluid is proximate the bottom 136 of the pour-over bag 102 and the pour-over bag 102 can receive more fluid, and the computing device 124 turns on the pump 118 to pour more fluid into the opening 106 and onto the beverage precursor. Thus, the second level detector 132 enables the computing device 124 to better control the brewing process and to prevent the pour-over bag 102 from overfilling with the fluid.

The level detection system 128 may also include a third level detector 134. The third level detector 134 is positioned proximate the top 138 of the cup 104. The third level detector 134 monitors and detects the temperature of the top 138 of the cup 104. The third level detector 134 is configured to turn off the pump 118 when the temperature of the top 138 of the cup 104 exceeds a third predetermined temperature. Once the temperature of the top 138 of the cup 104 exceeds the third predetermined temperature, the level of the fluid is proximate the top 138 of the cup 104, and the computing device 124 turns off the pump 118 and indicates to the user that the brewing process is complete through the interface module 126. Thus, the third level detector 134 enables the computing device 124 to better control the brewing process and to prevent the cup 104 from overfilling with the fluid.

In alternative embodiments, the first, second, and third level detectors 130-134 maybe any type of detector that detects the level of the fluid within the pour-over bag 102 or the cup 104. For example, in some embodiments, the first, second, and third level detectors 130-134 maybe sonic, ultrasonic, optical, capacitive, and/or electric impedance level detectors. Additionally, the first, second, and third level detectors 130-134 may detect the level of the fluid within the pour-over bag 102 or the cup 104 by other indirect methods. For example, the first, second, and third level detectors 130-134 maybe weight detectors that detect the weight of the fluid within the pour-over bag 102 or the cup 104 and calculate the level of the fluid within the pour-over bag 102 or the cup 104 based on the weight. The first, second, and third level detectors 130-134 may detect the level within the pour-over bag 102 or the cup 104 using any method that enables the beverage brewing system 100 to operate is described herein. Additionally, in alternative embodiments, the beverage brewing system 100 does not include the first, second, and third level detectors 130-134. Rather, the beverage brewing system 100 includes a flow meter that measures a volume of the fluid dispensed by the beverage brewing system 100 that controls the level of the fluid within the pour-over bag 102 or the cup 104 based on the flow rate of the fluid. In alternative embodiments, the level detectors could be used in conjunction with alternate methods (such as a flow meter) to achieve precise control of the fluid delivery.

In order to brew the best quality beverages, the nozzle assembly 114 may include an oscillation mechanism 140 to oscillate all or part of the holder 122 as the fluid is poured into the opening 106 onto the beverage precursor. Oscillating the holder 122 as the fluid is poured into the opening 106 ensures that the fluid more completely covers the beverage precursor and the fluid steeps in substantially all of the beverage precursor. For example, if the holder 122 is static, some of the beverage precursor may not contact the fluid during the steeping process. Accordingly, the oscillation mechanism 140 ensures that the highest quality beverage is brewed. In an alternate embodiment, the nozzle assembly (fluid delivery system) may be oscillated relative to the beverage precursor to similarly achieve improve fluid delivery.

The oscillation mechanism 140 includes a motor 142, a crank 144 attached to the motor 142, and a crank shaft 146 attached to the crank 144. The holder 122 is attached to the crankshaft 146. As shown in FIG. 4, illustrating a top view of the oscillation mechanism 140, the crank 144 has a circular base 150, an oscillation pin 152 extending from the circular base 150, and a motor pin 154 extending from a center 156 of the circular base 150. The oscillation pin 152 is attached to the circular base 150 in an off-center position. The crank shaft 146 is sized and shaped to interface with the crank 144 such that the holder 122 oscillates while the fluid is poured into the opening 106. Specifically, the crankshaft 146 includes a first end 158 attached to the crank 144 and a second end 160 attached to the holder 122. The first end 158 defines a slot 162 for receiving the oscillation pin 152. The second end 160 at least partially defines the holder 122.

During operations, the oscillation mechanism 140 converts rotational motion of the motor 142 into linear reciprocating motion of the holder 122 to ensure that the fluid completely covers the beverage precursor and brews a high-quality beverage. Specifically, the motor 142 rotates the crank 144 including the oscillation pin 152. Because the oscillation pin 152 is positioned at an off-center position on the circular base 150, the oscillation pin 152 rotates about the center 156 of the circular base 150. The oscillation pin 152 is movably positioned within the slot 162 such that the oscillation pin 152 is slidably attached to the first end 158 of the crankshaft 146. As the oscillation pin 152 rotates about the center 156 of the circular base 150, the oscillation pin 152 slides within the slot 162 and oscillates the first end 158 of the crankshaft 146. Oscillation of the first end 158 of the crankshaft 146 also oscillates the second end 160 of the crankshaft 146 and the holder 122. As the holder 122 oscillates from side to side, the fluid is poured into the opening 106 and onto all the beverage precursor, ensuring that the fluid completely covers the beverage precursor and the fluid steeps in all the beverage precursor. Accordingly, the oscillation mechanism 140 increases the quality of the beverage that is brewed by the beverage brewing system 100.

In alternative embodiments the oscillation mechanism 140 may be any mechanism that oscillates the holder 122 and/or an outlet tube 148 of the nozzle assembly 114. For example, in alternative embodiments the oscillation mechanism 140 may include a treadle linkage, a peg and slot linkage, a rack and pinion gear, a crank, link, and slider system, a cam and follower system, and/or any mechanism that generates linear reciprocating motion of the holder 122 and/or the outlet tube 148. Additionally, in another alternative embodiment, the outlet tube 148 may be designed to evenly cover the beverage precursor as the fluid is poured into the pour-over bag 102 through the opening 106. For example, the outlet tube 148 may include a plurality of outlets arranged in a pattern to more evenly distribute the fluid and/or cover the beverage precursor with the fluid as the fluid is poured into the pour-over bag 102 through the opening 106.

The holder 122 includes a first arm 164 and a second arm 166, the combination of which may be referred to herein as an arm assembly, extending from the case 110 within the cup reception bay 112. The first and second arms 164 and 166 each include a pin 168 extending upward toward the nozzle assembly 114. The pins 168 are sized and shaped to interface with the pour-over bag 102 to position the pour-over bag 102 above the cup 104 as the beverages brewed. Specifically, the pins 168 have a cone shape that extend into a portion of the pour-over bag 102 to maintain the pour-over bag 102 in position above the cup 104 and below the nozzle assembly 114. In alternative embodiments, the first and second arms 164 and 166 and the pins 168 may have any shape that enables the first and second arms 164 and 166 and the pins 168 to maintain the position of the pour-over bag 102 within the cup reception bay 112 as the beverages brewed. As alluded to above herein, and in an embodiment, the arm assembly is configured to move the pour-over bag 102 (e.g., rotationally about a vertical axis) underneath nozzle assembly 114 such that water is evenly distributed over the contents of pour-over bag to agitate/mix the water from the nozzle assembly and the pour-over bag contents. In one or more embodiments, water dispensed by nozzle assembly 114 can be intermittently distributed (i.e., stopping and starting water distribution at intervals) over the contents of pour-over bag 102 to mimic the manual “pour-over” coffee method until the desired volume of water is dispensed.

As shown in FIGS. 6 and 7, the reservoir 116 includes a level detector 161 for detecting a level of the fluid in the reservoir 116. In some embodiments, the level detector 161 is an IR sensor that detects the level of the fluid in the reservoir 116. In the illustrated embodiment, the level detector 161 includes a float 163 positioned within the reservoir 116 and a detector 165 positioned proximate the reservoir 116 for detecting the float 163 in the reservoir 116. Specifically, the reservoir 116 is made of a transparent material and the detector 165 is an optical detector that optically detects the float 163 and the level of the fluid in the reservoir 116. The float 163 floats in the fluid within the reservoir 116 and the float 163 has a marker or other indicator 167 that the optical detector 165 detects. The optical detector 165 transmits the level of the fluid to the computing device 124, and the computing device 124 transmits the level of the fluid to the interface module 126. The interface module 126 may display the level of the fluid to the user or indicates when the level of the fluid is low. In alternative embodiments, the level detector 161 may be any level-detecting device that enables the beverage brewing system 100 to operate as described herein. In one or more embodiments, and as best shown in FIG. 6, heating element 120 may be positioned within a boiler element 121 in which may be disposed a level-detecting device (not shown). Such a level-detecting device can include two metal conductive rods to which is driven a high-frequency AC signal between the two rods, wherein the output signal is proportional to the water level within boiler element 121. A single rod can also be used if the signal is driven between the rod and a metal boiler element 121. Alternatively, a plurality of rods may be used of varying lengths to determine a current or voltage change detected when the water level comes into contact with any of the rods, thereby indicating the volume of water at each rod location. Other level sensing methods may include weighing the boiler element 121, as well as IR sensors, ultrasonic sensors, and/or capacitive sensors appropriately positioned within the boiler element. In an embodiment, system 100 includes a tube (not shown) coupled to boiler element 121 that forces air down to the approximate bottom of the boiler element during heating such that water within the boiler element is mixed to maintain the water at a uniform temperature.

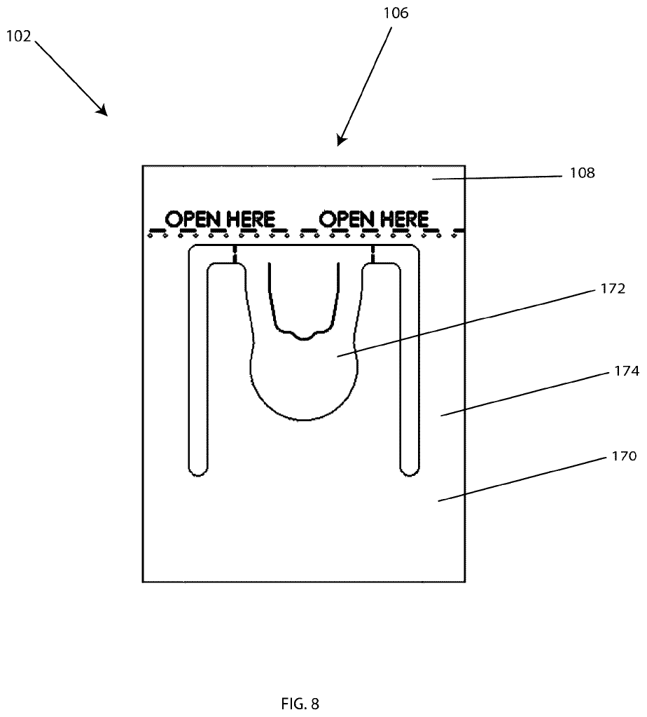

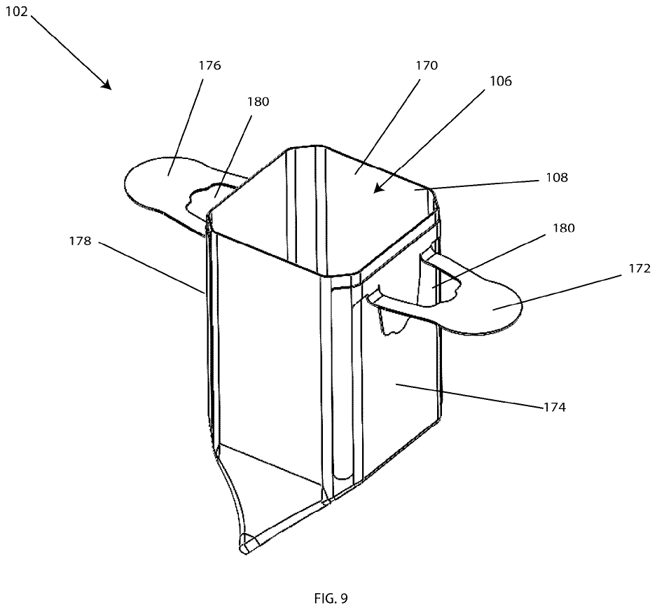

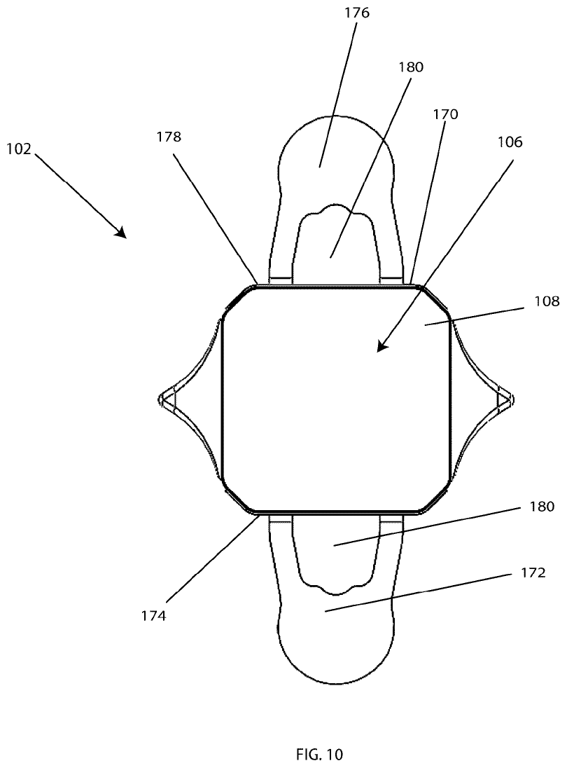

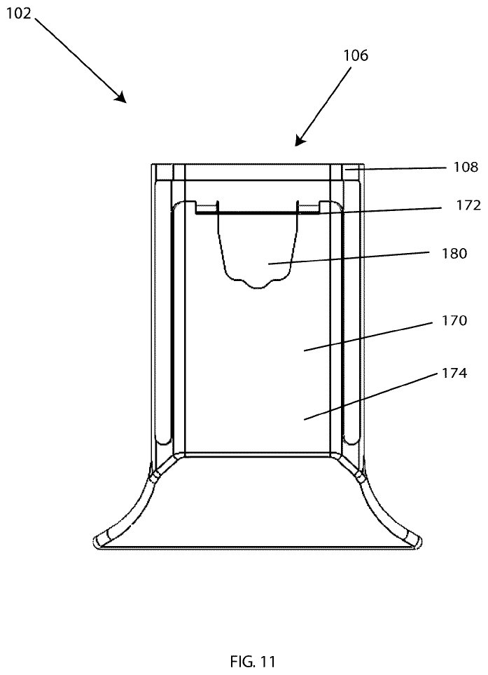

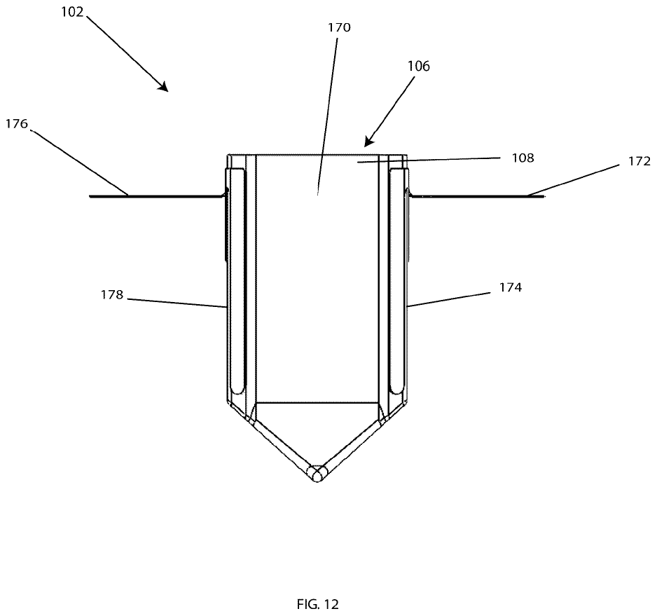

FIG. 8 illustrates a side view of the pour-over bag 102 in a first, flat configuration. FIG. 9 is a perspective view of the pour-over bag 102 in a second, expanded configuration. FIG. 10 is a top view of the pour-over bag 102 in the second, expanded configuration. FIG. 11 is a side view of the pour-over bag 102 in the second, expanded configuration. FIG. 12 is another side view of the pour-over bag 102 in the second, expanded configuration. The pour-over bag 102 includes a filter portion 170, a first hanger 172 attached to a first side 174 of the filter portion 170, and a second hanger 176 attached to a second side 178 of the filter portion 170. As shown in FIG. 8, in the first, flat configuration, the pour-over bag 102 is folded such that the filter portion 170 and the first and second hangers 172 and 176 are substantially flat for storage. As shown in FIGS. 9-12, in the second, expanded configuration, the pour-over bag is expanded such that the filter portion 170 defines the opening 106 and the first and second hangers 172 and 176 extend from the first and second sides 174 and 178 of the filter portion 172.

Specifically, the first and second hangers 172 and 176 are configured to extend substantially perpendicularly from the first and second sides 174 and 178 of the filter portion 172.

Additionally, the first and second hangers 172 and 176 are sized and shaped to define pin reception holes 180 when the first and second hangers 172 and 176 extend from the first and second sides 174 and 178 of the filter portion 172. The pin reception holes 180 are sized and shaped to receive the pins 168 therein when the pour-over bag 102 is hung from the holder 122. In the illustrated embodiment the first and second hangers 172 and 176 and the filter portion 170 define the pin reception holds 180.

In the illustrated embodiment, the filter portion 170, the first hanger 172, and the second hanger 176 are made from environmentally friendly, biodegradable or compostable materials. For example, in the illustrated embodiment, the filter portion 170 is a bag made from an environmentally friendly flexible material, such as organically derived polylactic acid (PLA) fiber or fiber blends with varying mixes of plant material (e.g., abaca, cellulose) and PLA, that retains the beverage precursor within the pour-over bag 102 while allowing the beverage fluid to seep through the bag. The first and second hangers 172 and 176 are made from an environmentally friendly rigid material that maintains the position of the pour-over bag 102 above the cup 104 during the brewing process. In alternative embodiments, the filter portion 170, the first hanger 172, and the second hanger 176 are made from any material (preferably from a biodegradable, or compostable environmentally friendly cup stock) that enables the pour-over bag 102 to operate as described herein.

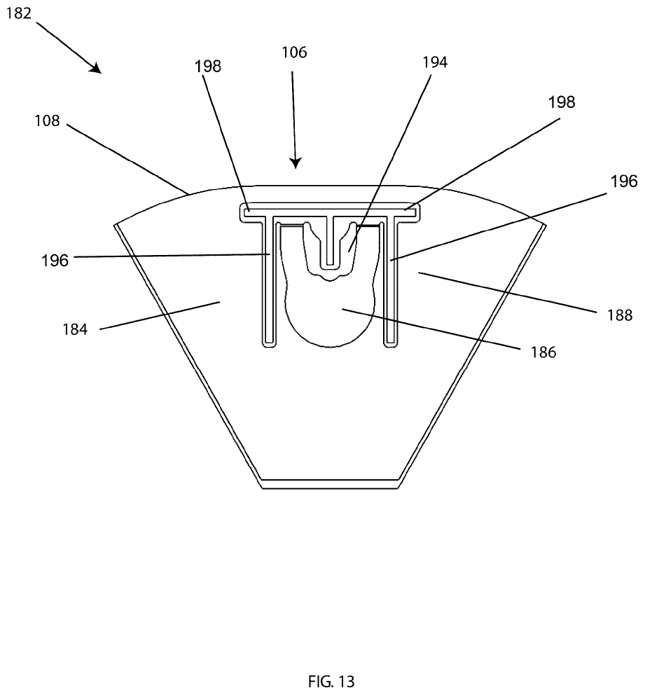

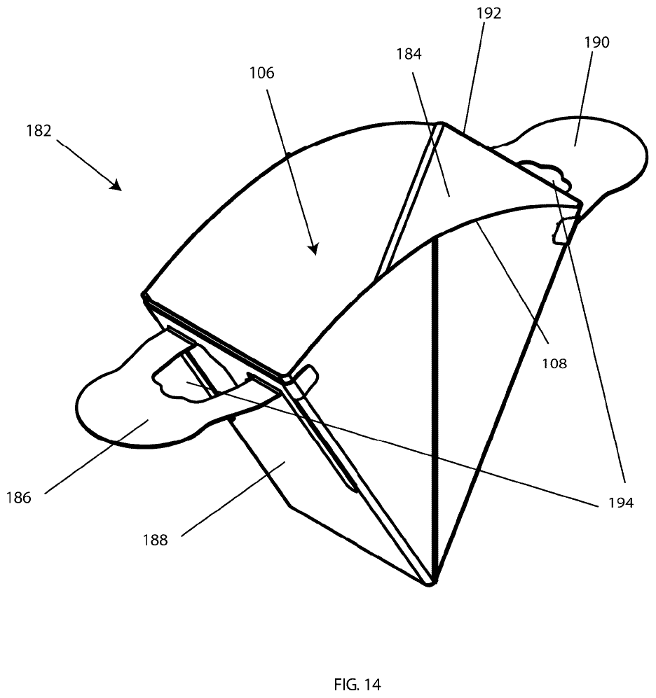

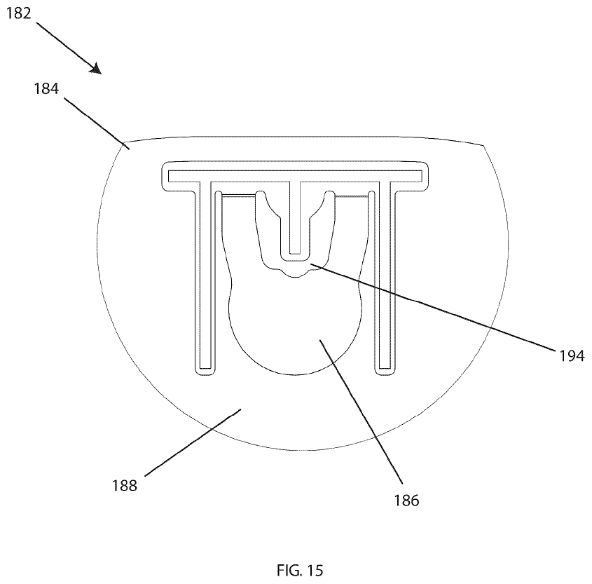

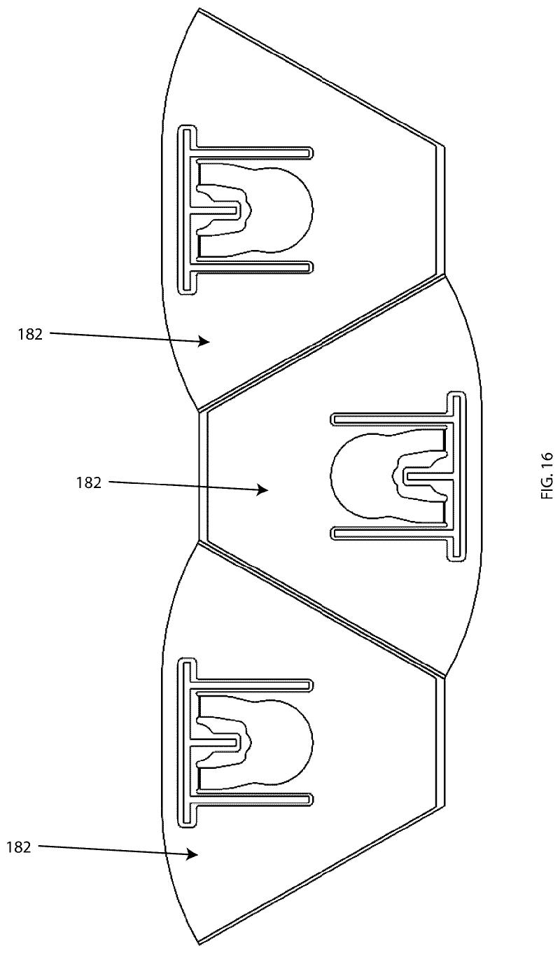

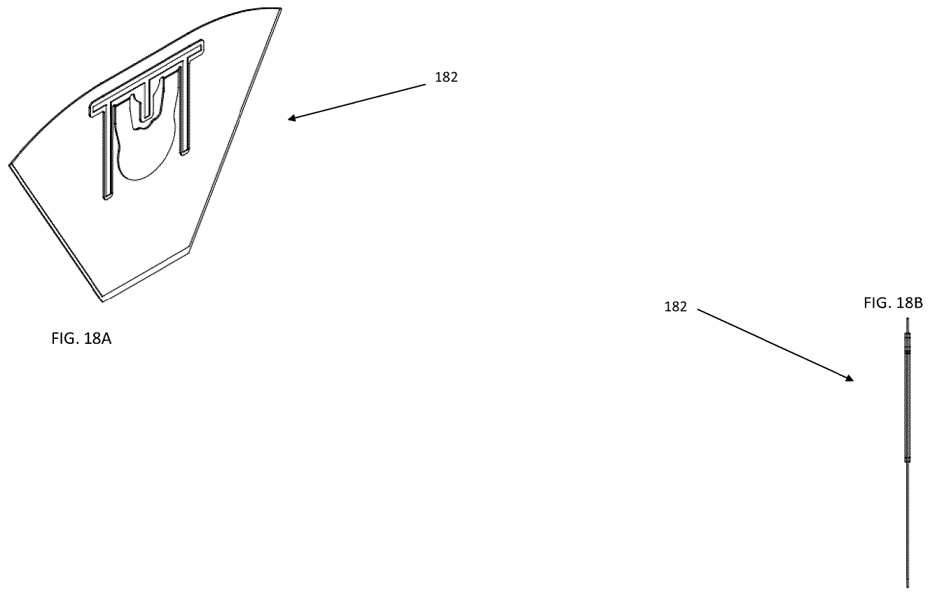

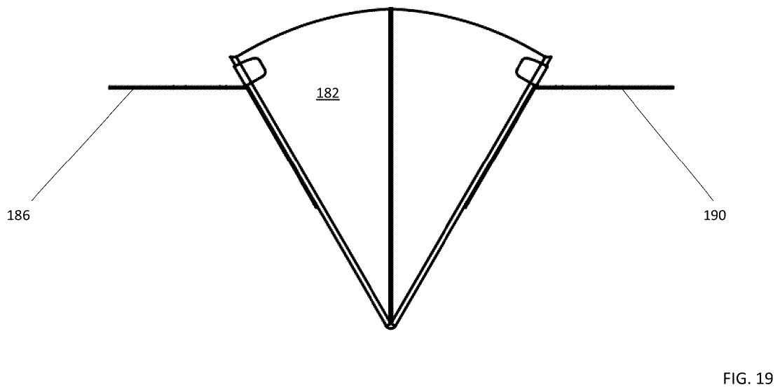

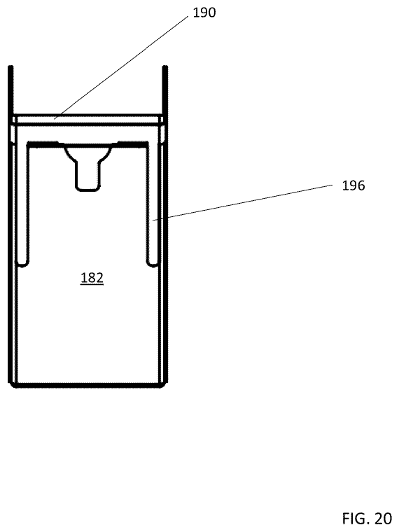

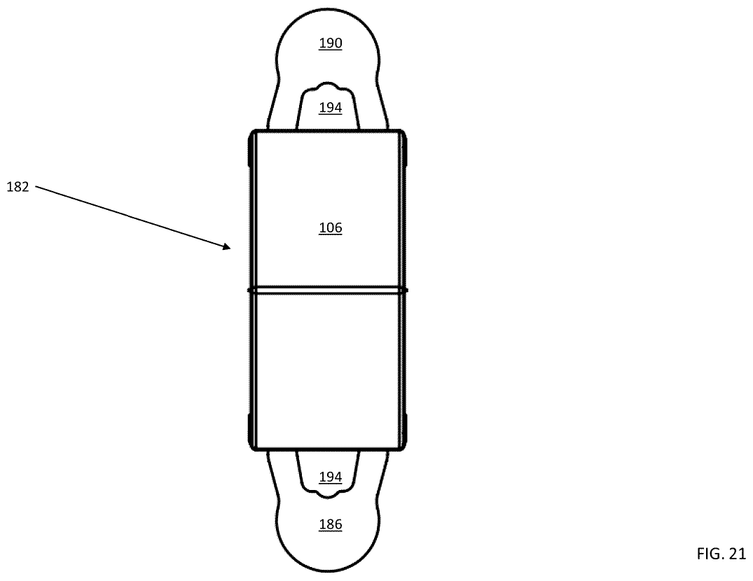

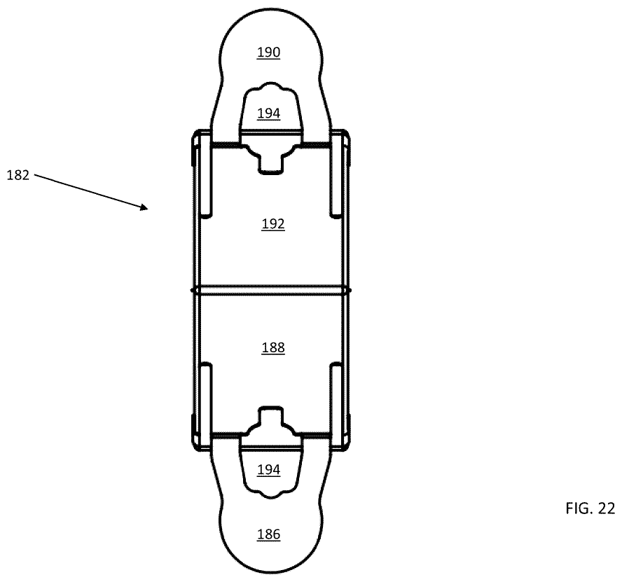

FIGS. 13-16 and 18A-22 illustrate an alternative pour-over bag 182 in accordance with the present disclosure. FIG. 13 illustrates a side view of the alternative pour-over bag 182 in a first, flat configuration. FIG. 14 is a perspective view of the pour-over bag 182 in a second, expanded configuration. FIG. 15 is a side view of a portion of the pour-over bag 182. FIG. 16 is a side view of a plurality of pour-over bags 182 in the first, flat configuration during the manufacturing process. The pour-over bag 182 includes a filter portion 184, a first hanger 186 attached to a first side 188 of the filter portion 184, and a second hanger 190 attached to a second side 192 of the filter portion 184. As shown in FIG. 13, in the first, flat configuration, the pour-over bag 182 is folded such that the filter portion 184 and the first and second hangers 186 and 190 are substantially flat for storage. As shown in FIG. 14, in the second, expanded configuration, the pour-over bag is expanded such that the filter portion 184 defines the opening 106 and the first and second hangers 186 and 190 extend from the first and second sides 188 and 192 of the filter portion 184. Specifically, the first and second hangers 186 and 190 are configured to extend substantially perpendicularly from the first and second sides 188 and 192 of the filter portion 184.

Additionally, the first and second hangers 186 and 190 are sized and shaped to define pin reception holes 194 when the first and second hangers 186 and 190 extend from the first and second sides 188 and 192 of the filter portion 186. The pin reception holes 194 are sized and shaped to receive the pins 168 therein when the pour-over bag 182 is hung from the holder 122. In the illustrated embodiment the first and second hangers 186 and 190 and the filter portion 184 define the pin reception holes 194.

Furthermore, the first and second hangers 186 and 190 each include at least one vertical support 196 and at least one horizontal support 198. In the illustrated embodiment, the first and second hangers 186 and 190 each include two vertical supports 196 and two horizontal supports 198. The vertical supports 196 support the pour-over bag 182 in the second, expanded configuration. The horizontal supports 198 extend to the side of the pour-over bag 182 when the pour-over bag 182 is in the second, expanded configuration and are configured to hold the pour-over bag 182 open when the pour-over bag 182 is in the second, expanded configuration.

In the illustrated embodiment, the filter portion 184, the first hanger 186, and the second hanger 190 are made from environmentally friendly, biodegradable or compostable materials. For example, in the illustrated embodiment, the filter portion 184 is a bag made from an environmentally friendly material that retains the beverage precursor within the pour-over bag 182 while allowing the beverage fluid to seep through the bag. The first and second hangers 186 and 190 are made from an environmentally friendly rigid material, such as a wood-pulp-or cellulose based cup stock board, coated on one or two sides with PLA (or other eco-friendly flexible fluid resistant and sealable material, that maintains the position of the pour-over bag 182 above the cup 104 during the brewing process. In alternative embodiments, the filter portion 184, the first hanger 186, and the second hanger 190 are made from any material that enables the pour-over bag 182 to operate as described herein. In varying embodiments, pour-over bags 102, 182 can be constructed using two layers of the flexible, preferably environmentally friendly, filter material heat-sealed or ultrasonically welded (or any other bonding method) together to form a pour-over bag to enable formation of the opening 106. Further, and in varying embodiments, each of the first and second hangers can be heat-sealed or ultrasonically welded to the opposite sides of the filter portion. Each hanger can be constructed to extend outward and mate with a separate element of brewing system 100 or other device that holds the pour-over bag open using, for example, pins, clips, adhesive, etc. The holding device can be the arms of a coffee machine or a device that holds the pour-over bag open to assist with adding grounds (e.g., manually or under a coffee grinder) or a device that holds the pour-over bag open while sitting on a coffee cup to allow water to be poured into the pour-over bag for brewing straight into the cup.

The pour-over bag 182 is substantially similar to the pour-over bag 102 except the filter portion 184 of the pour-over bag 182 has a conical shape while the filter portion 170 of the pour-over bag 102 has a rectangular shape. In alternative embodiments of the invention, a pour-over bag similar in functionality to that of pour-over bags 102, 182 can have a “V” shape or trapezoidal shape. In an embodiment a pour-over bag can have an isosceles trapezoidal shape with the hangers attached to each angled (i.e., creased) portion of the pour-over bag. The conical shape of the filter portion 184 of the pour-over bag 182 improves the coverage of the beverage precursor with the fluid by exposing more of the beverage precursor to the nozzle assembly 114. Additionally, as shown in FIG. 16, the conical shape of the filter portion 184 of the pour-over bag 182 enables the filter portion 184 of the pour-over bag 182 to be manufactured as a sheet and separated during the manufacturing process. Accordingly, the conical shape of the filter portion 184 of the pour-over bag 182 may reduce the cost of the manufacturing process and may improve the quality of the beverage brewed by the beverage brewing system 100.

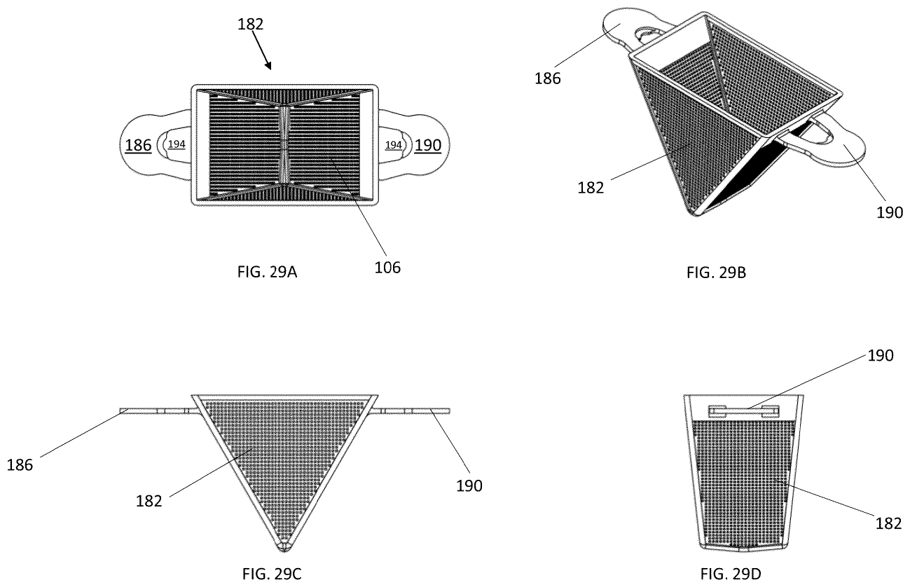

FIGS. 29A-29D illustrate a reusable pour-over bag structurally and functionally similar to that illustrated in FIG. 14 in accordance with the present disclosure and in which for the sake of brevity like structural elements are numbered using the reference numerals employed in FIG. 14. In such an embodiment first and second sides 188 and 192 of the filter portion 184 can be of a durable washable substance such as, for example, metal (e.g., gold or stainless steel) or a mesh fabric, and hangers 186, 190 can be of a durable and washable substance such as, for example, plastic.

Additionally, the beverage brewing system 100 may include a plurality of sensors that enable the computing device 124 to control the brewing process. For example, the beverage brewing system 100 may include a sensor that detects whether the pour-over bag 106 is positioned on the holder 122. Additionally, the beverage brewing system 100 may also include a sensor to detect the presence of the cup 104 within the cup reception bay 112. The beverage brewing system 100 may further include sensors to detect the temperature of the fluid in the heating element 120, the presence of the reservoir 116 in the case 110 if the reservoir 116 is removable from the case 110, and/or waste fluid in a waste fluid reservoir (not shown). The beverage brewing system 100 may also include pressure sensors, vibration sensors, or other sensors to detect a pre-boil state of the water in the heating element 120, to prevent boiling over of water when the set point exceeds the boiling point, such as at higher altitudes. The additional sensors enable the beverage brewing system 100 to detect and handle user error cases.

The level detection system 128 and the plurality of sensors enable the computing device 124 to control the brewing process. Specifically, the computing device 124 is configured to execute a precisely timed fluid delivery algorithm to optimize the brewing process. More specifically, the computing device 124 controls the pump 118 to control an initial fluid delivery into the pour-over bag 102 to generate a bloom or swelling of the beverage precursor. For example, if the beverage precursor is coffee grounds and the brewed beverage is coffee, the computing device 124 controls the initial fluid delivery into the pour-over bag 102 to generate a coffee bloom or swelling of the coffee grounds prior to the full pour-over of the fluid. Additionally, after the initial delivery of fluid, the computing device 124 pauses the flow of fluid into the pour-over bag 102 prior to the full pour-over to allow time for carbon dioxide entrapped in the coffee grounds during the roasting process to fully release. The computing device 124 then controls the pour-overflow rate into the pour-over bag 102 to optimize flavor extraction from the beverage precursor. Additionally, the computing device 124 evenly distributes the fluid over the beverage precursor during pour-over to optimize flavor extraction from the beverage precursor. Accordingly, the level detection system 128, the plurality of sensors, and the computing device 124 precisely controlled the brewing process to optimize flavor extraction from the beverage precursor.

During operations, the user unfolds the pour-over bag 102 from the first, flat configuration to the second, expanded configuration, defining the opening 106. The user then extends the first and second hangers 172 and 176 such that the first and second hangers 172 and 176 extend substantially perpendicularly from the first and second sides 174 and 178 of the filter portion 172. In the illustrated embodiment, the pour-over bag 102 is pre-filled with the beverage precursor (e.g., coffee, tea, etc.). In an embodiment, such a pre-filled pour-over bag can be heat-sealed or ultrasonically welded/sealed closed at the top to form a pouch with such seal being easily breakable to expose the precursor. In such an embodiment, the pour-over bag may be configured such that the user can open the bag by pulling on each hanger to break the seal at the top of the bag. In an alternative embodiment, the pre-filled pour-over bag has a perforated closed top that can be easily removed to open the pour-over bag. In an alternative embodiment, the beverage brewing system 100 may include a grinder (not shown) that grinds the beverage precursor and fills the pour-over bag 102 with the beverage precursor. In another alternative embodiment, the user pours the beverage precursor into the opening 106 and hangs the pour-over bag 102 on the hanger 122. Specifically, the user places the pour-over bag 102 on the holder 122 by inserting the pins 168 into the pin reception holds 180 such that the pour-over bag 102 hangs from the first and second arms 164 and 166 over the cup 104 and under the nozzle assembly 114. The user positions the cup 104 under the pour-over bag 102 and selects the type of beverage the user wants using the interface module 126. The beverage brewing system 100 automatically brews the selected beverage.

Specifically, the computing device 124 controls the pump 118, the heating element 120, the nozzle assembly 114, and the level detection system 128 to brew the selected beverage. The pump 118 pumps the fluid from the reservoir 116 through the heating element 120. The heating element 120 increases the temperature of the fluid to a predetermined beverage temperature. The beverage brewing system 100 may also include pressure sensors, vibration sensors, or other sensors to detect a pre-boil state of the water in the heating element 120, to prevent boiling over of water when the set point exceeds the boiling point, such as at higher altitudes. The heated fluid is pumped to the nozzle assembly 114. The nozzle assembly 114 pours the heated fluid through the opening 106 onto the beverage precursor while oscillating the holder 122 with the oscillation mechanism 140 as described above. The level detection system 128 detects the level of the fluid and/or the beverage fluid in at least one of the pour-over bag 102 and the cup 104 as described above. The heated fluid steeps in the beverage precursor and drips through the pour-over bag 102 into the cup 104. The computing device 124 pauses pouring the fluid onto the beverage precursor if the level detection system 128 detects that the level of the fluid within the pour-over bag 102 is proximate the top 108 of the pour-over bag 102. The computing device 124 resumes pouring the fluid onto the beverage precursor if the level detection system 128 detects that the level of the fluid within the pour-over bag 102 is proximate the bottom 136 of the pour-over bag 102, the temperature at the top 108 of the bag has dropped by a certain percentage or amount, or by monitoring the rate of change of the temperature at the top 108 or bottom 136 of the pour over bag 102. Once the cup 104 has been filled or the boiler has been determined to have been drained as detected by pressure sensor changes, pressure sensor absolute values, or water level electrodes in the boiler element 121, the beverage brewing system 100 stops pumping the fluid to the nozzle assembly 114 and the user removes the cup 104 from the cup reception bay 112.

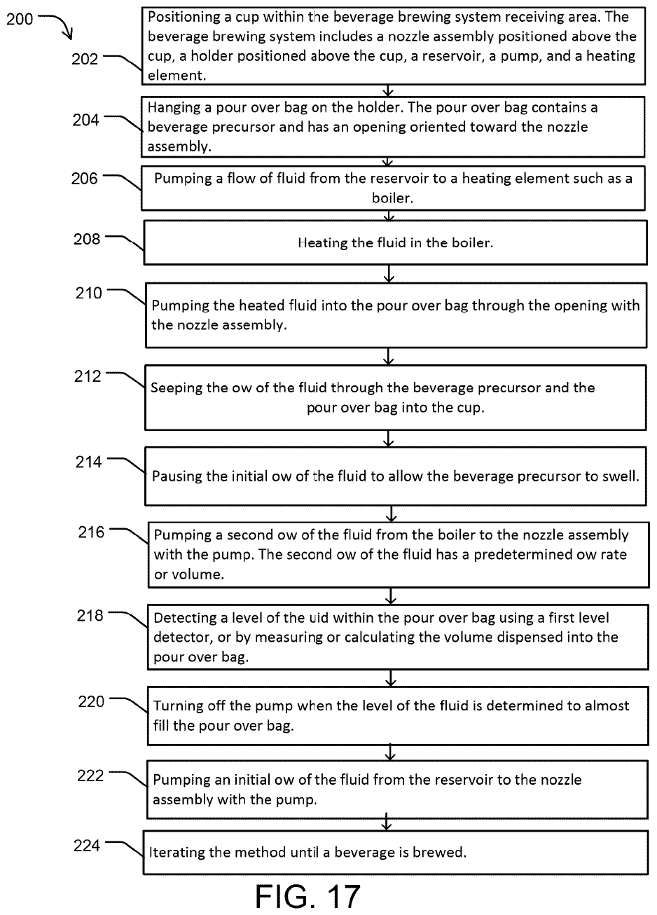

FIG. 17 illustrates a method 200 of brewing a beverage with a beverage brewing system. The method 200 includes positioning 202 a cup within a cup reception bay of the beverage brewing system. The beverage brewing system includes a nozzle assembly positioned above the cup, a holder positioned above the cup, a reservoir, a pump, and a heating element. The method 200 also includes hanging 204 a pour-over bag on the holder. The pour-over bag contains a beverage precursor and has an opening oriented toward the nozzle assembly. The method further includes pumping 206 a flow of a fluid from the reservoir to the nozzle assembly with the pump. The method 200 also includes heating 208 the flow of the fluid with the heating element. The method 200 further includes pouring 210 the flow of the fluid into the pour-over bag through the opening with the nozzle assembly. The method 200 also includes seeping 212 the flow of the fluid through the beverage precursor and the pour-over bag into the cup.

The method 200 may also include pausing 214 the initial flow of the fluid to allow the beverage precursor to swell. The method 200 may further include pumping 216 a second flow of the fluid from the reservoir to the nozzle assembly with the pump. The second flow of the fluid has a predetermined flow rate. The method 200 may also include detecting 218 a level of the fluid within the pour-over bag using a first level detector. The first level detector includes at least one infrared temperature detector or any other temperature sensor such as a thermistor. The method 200 may further include turning off 220 the pump when the level of the fluid exceeds a predetermined temperature. Additionally, pumping 206 a flow of a fluid from the reservoir to the nozzle assembly with the pump may include pumping 222 an initial flow of the fluid from the reservoir to the nozzle assembly with the pump. The method 200 may also include iterating 224 the method 200 until a beverage is brewed.

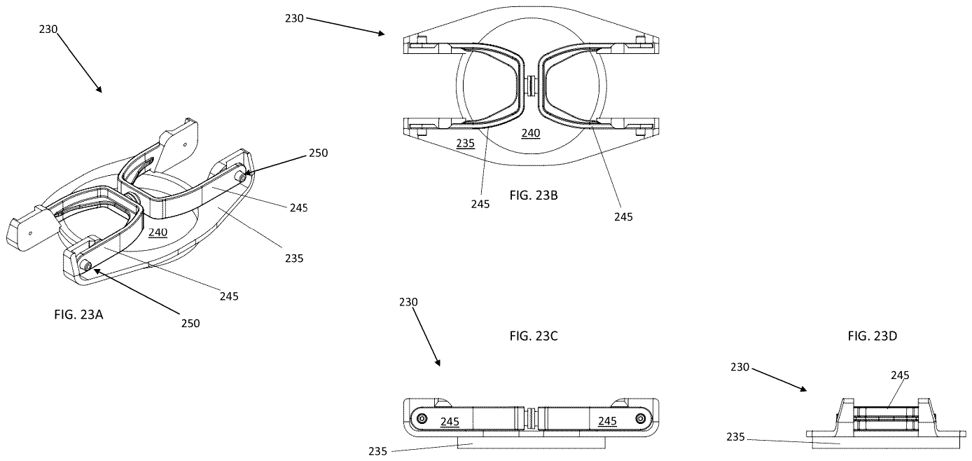

FIGS. 23A-23D are, respectively, a top perspective view, a top view, a first side view and a second side view of a holder assembly 230 of a first embodiment in a folded configuration in accordance with the present disclosure. Holder assembly 230 includes a base 235 through which an aperture 240 is formed. A pair of support arms 245 are attached to the base 235 by a pivot mechanism such as a pair of pins 250.

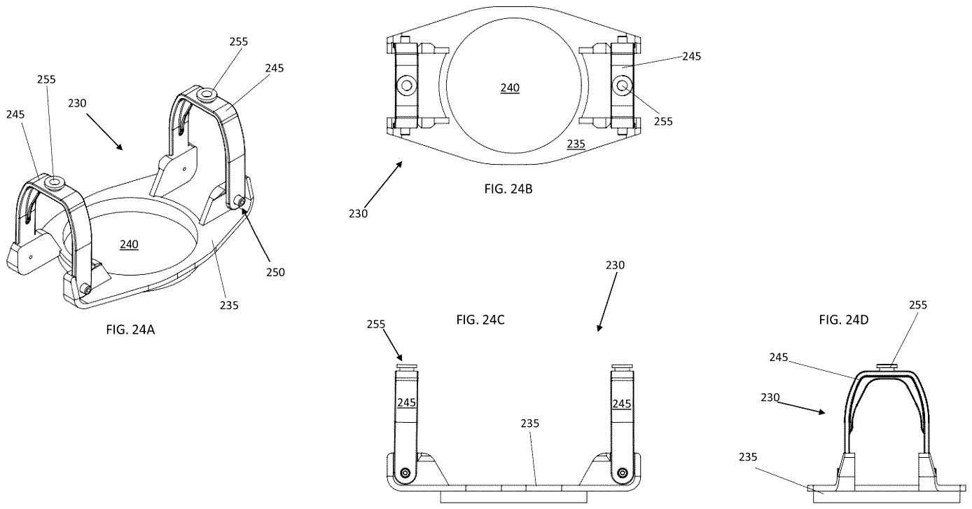

FIGS. 24A-24D are, respectively, a top perspective view, a top view, a first side view and a second side view of the holder assembly 230 of FIGS. 23A-23D in an unfolded configuration in accordance with the present disclosure. As can best be seen in these figures, each of support arms 245 includes a knob 255 formed on a surface of the support arms distal from the pins 250.

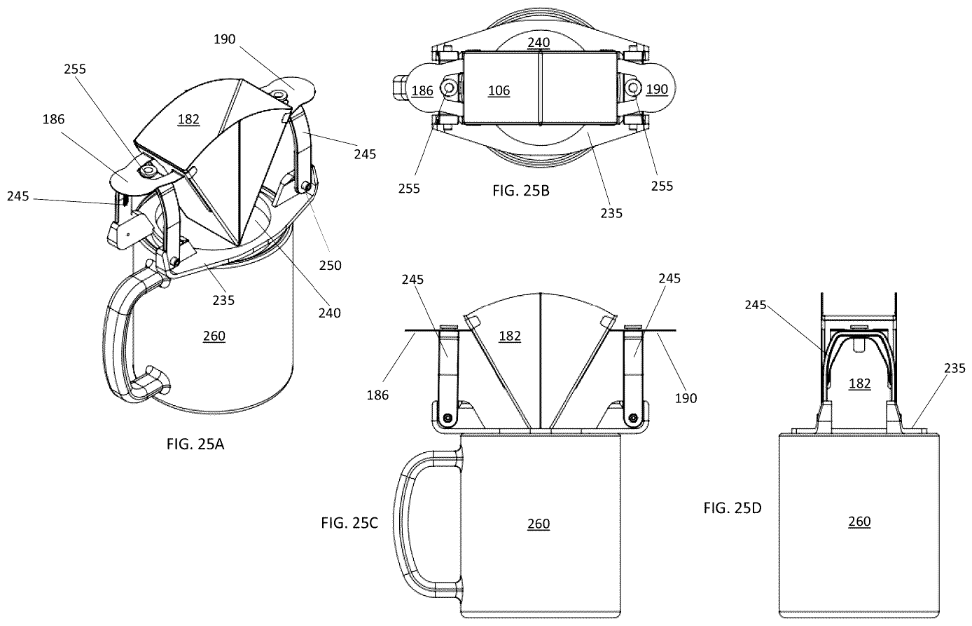

FIGS. 25A-25D are, respectively, a top perspective view, a top view, a first side view and a second side view of the pour-over bag 182 illustrated in FIG. 14, a cup 260, and the holder assembly 230 of FIGS. 24A-24D. As can best be seen in these figures, a user can prepare a beverage from the contents of a pour-over bag 182 by setting the base 235 of the unfolded holder assembly 230 on the upper rim of the cup 260, hooking or otherwise securing the first and second hangers 186 and 190 to respective ones of the knobs 255, thereby suspending pour-over bag 182 over aperture 240, and pouring a liquid into opening 106.

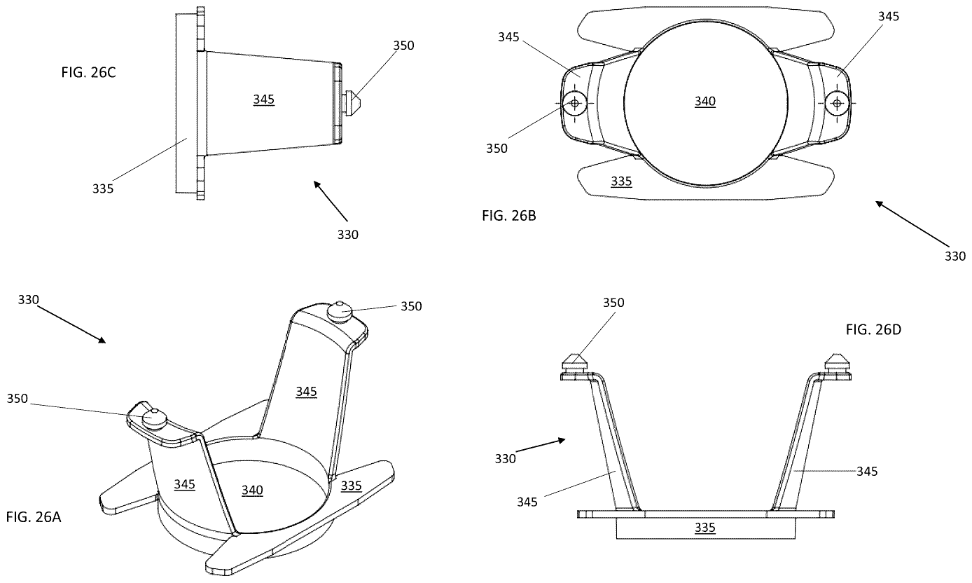

FIGS. 26A-26D are, respectively, a top perspective view, a top view, a first side view and a second side view of a holder assembly 330 of a second embodiment in accordance with the present disclosure. Holder assembly 330 includes a base 335 through which an aperture 340 is formed. A pair of support arms 345 are attached to the base 335. Each of support arms 345 includes a knob 350 formed on a surface of the support arms distal from the base 335.

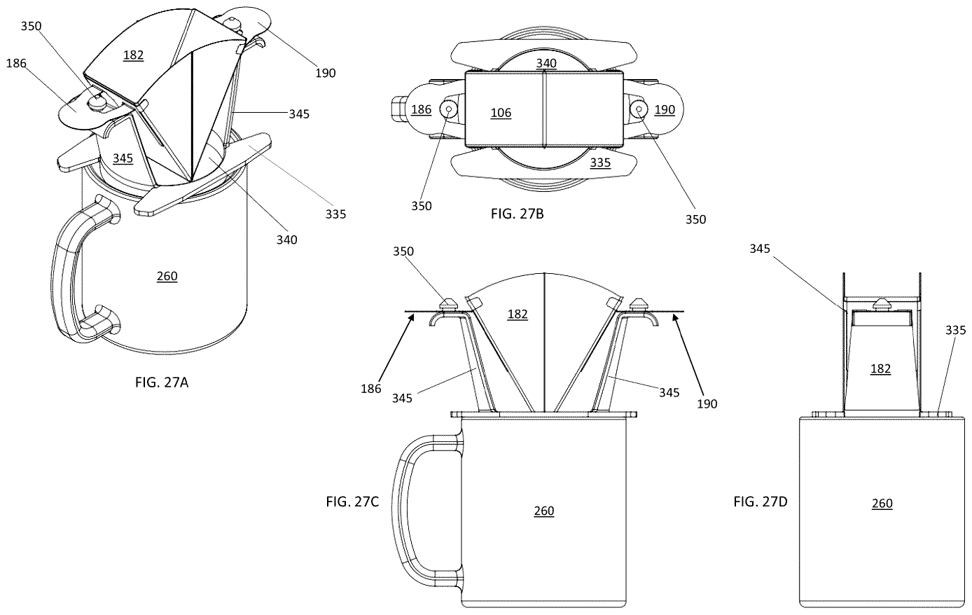

FIGS. 27A-27D are, respectively, a top perspective view, a top view, a first side view and a second side view of the pour-over bag 182 illustrated in FIG. 14, a cup 260, and the holder assembly 330 of FIGS. 26A-26D. As can best be seen in these figures, a user can prepare a beverage from the contents of a pour-over bag 182 by setting the base 335 of the unfolded holder assembly 330 on the upper rim of the cup 260, hooking or otherwise securing the first and second hangers 186 and 190 to respective ones of the knobs 350, thereby suspending pour-over bag 182 over aperture 340, and pouring a liquid into opening 106.

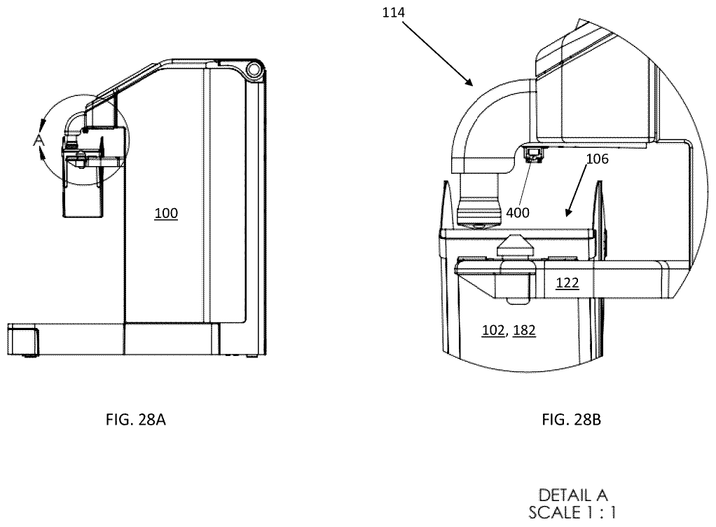

FIGS. 28A-28B are, respectively, a side view of an alternative embodiment of system 100 and a side magnified view of a region of system 100 indicated by circular arrow A. In this embodiment, a sensor 400 positioned to view down into opening 106 is mounted on or near nozzle assembly 114. The sensor 400 can be IR, thermal, or ultrasonic in operation. The sensor 400 is configured to provide feedback on the water/coffee level in the pour-over bag 102, 182. In an embodiment, instead of using two or more thermopiles to gauge the water level in the pour-over bag 102, 182 from directly behind the pour-over bag (i.e., horizontally), just one thermopile is positioned above the pour-over bag, mounted on or near nozzle assembly 114. In other words, sensor 400 looks directly down into the pour-over bag 102, 182 and is able to “see” the temperature change associated with the water rising in the pour-over bag. According to one or more alternative embodiments, one or more temperature probes such as, for example a thermistor, thermocouple, or other instrument appropriate to measure temperature can be located close to the top of the pour-over bag and can be used to determine when the pour-over bag is approaching full hot water capacity.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. For example, and in an embodiment, each pour-over bag can be marked or labeled with machine-readable indicia, such as a barcode, QR code, etc. or can incorporate a machine-readable wireless chip. In such an embodiment, brewing system 100 may be equipped with a suitable scanning device, and the respective positioning of the indicia/chip on the pour-over bag and scanning device on the brewing system are such that, once the pour-over bag is put in a brewing position, the scanning device can interrogate/read the indicia/chip. The scanning device can thusly retrieve information from the indicia/chip that, for example, validates the pour-over bag and/or sets brewing parameters for the brewing system 100. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A beverage brewing system comprising: a case;
a reservoir positioned within the case for containing a fluid;
a pump positioned within the case for moving the fluid from the reservoir to the nozzle assembly;
a heating element positioned within the case for heating the fluid;
a holder for holding a pour-over bag beneath the nozzle assembly, the pour-over bag having an opening configured to receive a beverage precursor, wherein the pour-over bag hangs from the holder with the opening oriented toward the nozzle assembly, the nozzle assembly pours the fluid into the pour-over bag through the opening, and the fluid flows through the beverage precursor and through the pour-over bag into a cup positioned beneath the pour-over bag.

2. The beverage brewing system of claim 1, further comprising a first level detector for detecting a level of the fluid within the pour-over bag.

3. The beverage brewing system of claim 2, wherein the first level detector comprises at least one temperature detector.

4. The beverage brewing system of claim 3, wherein the at least one temperature detector is positioned proximate a top of the pour-over bag and is configured to detect a temperature of the pour-over bag as the nozzle assembly pours the fluid into the pour-over bag, and wherein the at least one temperature detector is configured to turn off the pump when the temperature of the pour-over bag exceeds a first predetermined temperature.

5. The beverage brewing system of claim 4, wherein at least one temperature detector comprises a first temperature detector and the first level detector further comprises a second temperature detector positioned proximate a bottom of the pour-over bag and configured to detect the temperature of the pour-over bag as the nozzle assembly pours the fluid into the pour-over bag, and wherein the second temperature detector is configured to turn on the pump when the temperature of the pour-over bag decreases below a second predetermined temperature.

6. The beverage brewing system of claim 5, wherein the first temperature detector is positioned above the holder.

7. The beverage brewing system of claim 5, wherein the second temperature detector is positioned below the holder.

8. The beverage brewing system of claim 5, wherein at least one of the first and second temperature detectors comprise a thermopile infrared sensor, thermistor, or thermocouple.

9. The beverage brewing system of claim 1, wherein the nozzle assembly comprises a movable outlet nozzle and a cam system attached to the movable outlet nozzle, and wherein the cam system oscillates the movable outlet nozzle over the opening of the pour-over bag as the movable outlet nozzle pours the fluid into the pour-over bag through the opening to evenly cover the beverage precursor with the fluid.

10. The beverage brewing system of claim 1, wherein the nozzle assembly comprises a fixed outlet pipe and a nozzle attached to the fixed outlet pipe, the nozzle comprises a plurality of outlets arranged in a pattern to evenly cover the beverage precursor with the fluid as the nozzle pours the fluid into the pour-over bag through the opening.

11. The beverage brewing system of claim 1, further comprising a cup detector positioned within the case for detecting the cup beneath the outlet nozzle.

12. The beverage brewing system of claim 1, further comprising a case defining a cup reception bay for receiving a cup and a nozzle assembly positioned above the cup
reception bay, and further comprising a cup detector positioned within the cup reception bay for detecting the cup within the cup reception bay.

13. The beverage brewing system of claim 1, further comprising a second level detector for detecting a level of the fluid within the cup.

14. The beverage brewing system of claim 13, wherein the second level detector comprises at least one temperature detector.

15. The beverage brewing system of claim 14, wherein the at least one temperature detector is positioned proximate a top of the cup and is configured to detect a temperature of the cup as the nozzle assembly pours the fluid into the pour-over bag and the cup, and wherein the at least one temperature detector is configured to turn off the pump when the temperature of the cup exceeds a third predetermined temperature.

16. The beverage brewing system of claim 1, wherein the pour-over bag is biodegradable, compostable, and/or reusable.

17. The beverage brewing system of claim 1, further comprising a flow meter for measuring a volume of dispensed fluid.

18. The beverage brewing system of claim 17, wherein the flow meter comprises an inline flow meter.

19. The beverage brewing system of claim 17, wherein the flow meter is configured to measure a level of the fluid in the reservoir and determine the volume of dispensed fluid based on the measured level.

20. The beverage brewing system of claim 17, wherein the flow meter is configured to time the fluid flowing from the reservoir and determine the volume of dispensed fluid based on the measured time.

21. The beverage brewing system of claim 17, wherein the flow meter is configured to weigh the holder and determine the volume of dispensed fluid based on the measured weight.

22. A method of brewing a beverage with a beverage brewing system, the method comprising:
positioning a cup within the beverage brewing system, the beverage brewing system comprising a nozzle assembly positioned above the cup, a holder positioned above the cup, a reservoir, a pump, and a heating element;
hanging a pour-over bag on the holder, wherein the pour-over bag contains a beverage precursor and has an opening oriented toward the nozzle assembly;
pumping a flow of a fluid from the reservoir to the nozzle assembly with the pump by pumping the fluid or by pressurizing the reservoir with air pressure in the reservoir;
heating the flow of the fluid with the heating element;
pouring the flow of the fluid into the pour-over bag through the opening with the nozzle assembly; and
seeping the flow of the fluid through the beverage precursor and the pour-over bag into the cup.

23. The method of claim 22, wherein pumping a flow of a fluid from the reservoir to the nozzle assembly with the pump comprises pumping an initial flow of the fluid from the reservoir to the nozzle assembly with the pump by pumping the fluid or by pressurizing the reservoir with air pressure in the reservoir.

24. The method of claim 23, further comprising:
pausing the initial flow of the fluid to allow the beverage precursor to swell; and
pumping a second flow of the fluid from the reservoir to the nozzle assembly with the pump, wherein the second flow of the fluid has a predetermined flow rate.

25. The method of claim 22, further comprising detecting a level of the fluid within the pour-over bag using a first level detector, wherein the first level detector comprises at least one temperature detector; and
turning off the pump when the level of the fluid exceeds a predetermined temperature.
